(19) United States
(12) Patent Application Publication
(10) Pub. No.: US 2004/0141469 A1
(43) Pub. Date: Jul. 22, 2004

(54) Rake receiver for operating in FDD and TDD modes

(76) Inventors: Peter Jung, Otterberg (DE); Jorg Plechinger, Munchen (DE); Michael Schneider, Munchen (DE); Tideya Kella, Munchen (DE); Thomas Ruprich, Munchen (DE)

Correspondence Address: LERNER AND GREENBERG, PA, P O BOX 2480, HOLLYWOOD, FL, 33022-2480, US

(21) Appl. No.: 10/713,747

(22) Filed: Nov. 14, 2003

Related U.S. Application Data
(63) Continuation of application No. PCT/DE02/01095, filed on Mar. 25, 2002.

(30) Foreign Application Priority Data
May 14, 2001 (DE) 101 23 334.5

(51) Int. Cl. H04J 1/00

(52) U.S. Cl. 370/281

(57) ABSTRACT

A RAKE receiver is configured for receiving spread-coded signals in the FDD and TDD modes. The RAKE receiver contains two or more RAKE fingers. The RAKE fingers have an equalizer for equalization of the signals that are processed in the RAKE fingers. Equalizer coefficients are calculated selectively for the FDD and TDD modes, by a calculation unit. In the TDD mode, the equalizer coefficients are calculated using a multiple subscriber method for each chip in the signals to be equalized.

### CROSS-REFERENCE TO RELATED APPLICATION

This application is a continuation of copending International Application No. PCT/DE02/01095, filed Mar. 25, 2002, which designated the United States and was not published in English.

### BACKGROUND OF THE INVENTION

1. Field of the Invention

The invention relates to a RAKE receiver for reception of spread-coded signals in the FDD and TDD modes.

In the universal mobile telecommunications system (UMTS) standard for the third mobile radio generation, the frequency division duplex (FDD) mode is provided for the so-called “unpaired band” (which has separate frequency bands for the uplink and downlink directions) and the time division duplex (TDD) mode is provided for the “paired band” which uses a common frequency band for the uplink and downlink directions.

Owing to the widely differing spreading factors in these two modes (while the maximum spreading factor in the TDD mode is equal to 16, spreading factors up to 512 can be used in the FDD mode), it is necessary to use different receiver types and different equalizer algorithms in order on the one hand to ensure as low a level of signal processing complexity as possible in the FDD mode, and on the other hand to make it possible to provide a given quality of service (QoS) in the TDD mode.

In multimode mobile radio receivers, it is therefore generally necessary to implement a RAKE receiver with matched filter (MF) equalization for the FDD mode and a multiple subscriber receiver with joint detection (JD) equalization for the TDD mode.

RAKE receivers and multiple subscriber receivers are fundamentally different receiver concepts. RAKE receivers are based on the principle that the signal interference caused by multipath propagation can be suppressed by detecting the individual signal versions which are received via the various propagation paths, and then by joining the signal version together with the correct timing. Multiple subscriber detection is based on the idea of eliminating interference caused by other active mobile radio subscribers (so-called intracell interference) by explicit detection of the subscriber signals, that is to say making use of the fact that the interference caused by the activities of other subscribers is deterministic (not random noises).

The implementation of two different receiver structures in multimode mobile radio receivers has a disadvantageous effect on the production costs and, furthermore, has a disadvantageous effect on technical parameters such as power consumption. It is thus desirable to provide a common receiver structure, which is suitable for operation both in the FDD mode and in the TDD mode.

### SUMMARY OF THE INVENTION

It is accordingly an object of the invention to provide a RAKE receiver for operating in the FDD and TDD modes that overcomes the above-mentioned disadvantages of the prior art devices of this general type, which allows reception operation both in the FDD mode and in the TDD mode. A further aim of the invention is to provide a reception method that allows multimode FDD and TDD operation in a manner that is as simple as possible.

With the foregoing and other objects in view there is provided, in accordance with the invention, a RAKE receiver for receiving signals transmitted by different propagation paths of a transmission channel and spread-coded with chip sequences in frequency division duplex and time division duplex modes. The rake receiver contains at least two RAKE fingers, an equalizer connected to the RAKE fingers for equalization of the signals processed in individual ones of the RAKE fingers using equalizer coefficients, and a calculation unit for generating the equalizer coefficients for the FDD and TDD modes selectively. The equalizer coefficients for the TDD mode being calculated using a multiple subscriber method on a propagation path non-specific basis for each chip of the signals to be equalized, and being applied to the signals. The calculation unit is connected to the equalizer.

The receiver structure according to the invention is accordingly a RAKE receiver that has two or more RAKE fingers in the normal way. The RAKE fingers have an associated equalizer, using which the signals that are processed in the individual RAKE fingers are equalized using equalizer coefficients. The equalizer according to the invention has a unit for calculating the equalizer coefficients for the FDD and TDD modes selectively, for example on the basis of channel estimation. According to the invention, the equalizer coefficients for the TDD mode are in this case calculated using a multiple subscriber calculation method for each chip of the signals to be equalized, and are applied to the signals.

The invention is based on the knowledge that the RAKE receiver structure which has been used until now for individual subscriber detection on the basis of MF equalization can also be used for multiple subscriber detection (which is absolutely essential in the TDD mode), provided that equalizer coefficients are calculated—in contrast to the situation in the FDD mode—per chip, and are applied by the equalizer to the signals in the RAKE fingers. As will be explained in more detail in the following text, this makes it possible to carry out JD equalization by a RAKE structure that has only minor physical changes in comparison to a conventional RAKE receiver.

One advantageous exemplary embodiment of the invention is characterized in that a unit for signal rate reduction, in particular an accumulator, is provided in the signal path upstream of the equalizer in each RAKE finger, and in that a device is further provided for bridging the unit for signal rate reduction. The device for bridging the unit for signal rate reduction results in that the signal rate at the input of the equalizer can selectively be set to the symbol rate (which is required, for example, for MF equalization in the FDD mode) or to the chip rate (which is required for JD or multiple subscriber equalization in the TDD mode).

A further advantageous refinement of the RAKE receiver according to the invention is characterized in that a combiner is provided in the signal path downstream of the equalizer and accumulates output signals from RAKE fingers which are associated with the same physical channel, and in that the combiner is configured to carry out signal rate reduction from the chip rate to the symbol rate in the TDD mode. Therefore, the combiner additionally acts as an integrate and dump unit in the TDD mode, which accumulates the weighted chips which are emitted from the equalizer over one symbol time period and, as a consequence of this, converts the signal rate from the chip rate to the symbol rate.

A further advantageous embodiment variant of the RAKE receiver according to the invention is characterized in that a multiplexer is connected upstream of the equalizer (which is, in particular, in the form of a multiplication field), and a demultiplexer is connected downstream of it. The multiplexing of the equalizer that two or more RAKE fingers can be associated with a single function element (multiplier) of the equalizer.

The device for calculating the equalizer coefficients preferably carries out a zero forcing (ZF) calculation for determination of the equalizer coefficients in the TDD mode. ZF equalization is a simple JD equalization algorithm for calculation of the equalizer coefficients.

Other features which are considered as characteristic for the invention are set forth in the appended claims.

Although the invention is illustrated and described herein as embodied in a RAKE receiver for operating in the FDD and TDD modes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a simplified block diagram for explaining the structure of a baseband section of a RAKE receiver according to the invention;

FIG. 2 is a block diagram of a rake finger section and a combiner, as illustrated in FIG. 1, in greater detail;

FIG. 3 is a block diagram of the combiner, as illustrated in FIG. 2, in greater detail; and

FIG. 4 is an illustration for explaining joint detection equalization using a RAKE receiver.

### DESCRIPTION OF THE PREFERRED EMBODIMENTS

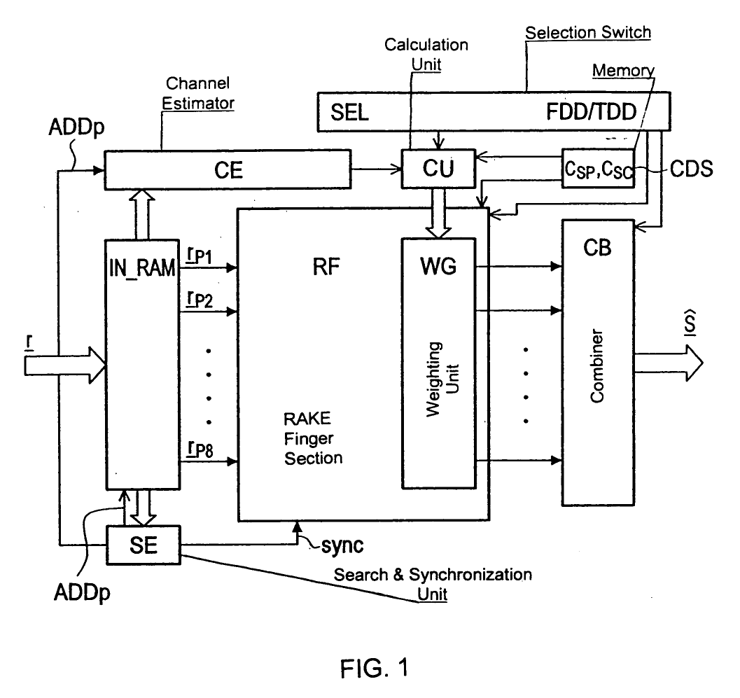

Referring now to the figures of the drawing in detail and first, particularly, to FIG. 1 thereof, there is shown a baseband section of a RAKE receiver according to the invention that has an input memory IN_RAM to which a signal containing a stream of complex data r is supplied. The input memory IN_RAM provides buffer storage for the data r.

The baseband data r is produced in the normal way, for example by a non-illustrated heterodyne stage. This contains, for example, a radio-frequency mixing stage which produces analog in-phase (I) and quadrature (Q) signal components from a signal received via an antenna, and down-mixes the signal components by frequency mixing to a suitable intermediate frequency or to a baseband. The down-mixed analog I and Q signal components are digitized by analog/digital converters. Digitization is carried out, for example, using a sampling rate of 2/T_{c}, where T_{c} is the chip time period of the received data signal. The individual chips of the spreading codes which are used for CDMA multiple access can thus be separated (in UMTS mobile radio systems, the chip time period is T_{c}=0.26 μs, that is to say a sampling rate of 2/T_{c} corresponds to approximately 8 MHz).

The digitized I and Q signal components are then smoothed in a likewise known manner, by a digital low-pass filter and, if necessary, their frequencies are corrected by a frequency correction unit.

A search and synchronization unit SE accesses the data r stored in the input memory IN_RAM and, on the basis of an evaluation of pilot symbols contained in this data or pilot symbols which have already been separated from the data signal, identifies the data structure of different signal versions which are received via different propagation paths, and identifies the timings of the signal versions.

Path information ADD_{P} determined by the search and synchronization unit SE and relating to the occurrence and number of different signal versions is passed to the input memory IN_RAM, and synchronization information Sync is supplied to a RAKE finger section RF of the RAKE receiver.

The RAKE finger section RF contains two or more RAKE fingers. The data r is distributed between different RAKE fingers by use of the path information ADD_{P} in a manner that will be explained in more detail later. The synchronization information Sync results in the data being synchronized in the RAKE fingers.

A weighting unit WG is disposed within the RAKE finger section RF, is formed from a hardware multiplication field and weights the signals in the individual RAKE fingers. The weighting unit WG is supplied with equalizer coefficients that are calculated by a calculation unit CU.

Output signals from the individual RAKE fingers are produced at the output of the RAKE finger section RF. These output signals are supplied to a combiner CB (for example a Maximum Ratio Combiner) in accordance with the normal configuration of a RAKE receiver. The combiner CB adds those signal versions that are processed in the individual RAKE fingers and are associated with a single physical channel, and emits a stream of estimated data symbols ŝ. That is to say, ŝ denotes the reconstructions, as determined at the receiver end, of the data symbols s transmitted from a transmitter.

The baseband section of the RAKE receiver, as illustrated in FIG. 1, also has a channel estimator CE that determines discrete impulse responses for the received physical channel or channels and for their different transmission paths.

The discrete-time impulse responses determined by the channel estimator CE are passed to the calculation unit CU, in order to calculate equalizer coefficients. The calculation unit CU calculates the equalizer coefficients as a function of the operating mode (FDD or TDD) that is intended to be carried out by the RAKE receiver. The desired operating mode is set via a selection switch SEL. The selected operating mode is signaled not only to the calculation unit CU but also to the RAKE finger section RF and to the combiner CB.

The spreading codes C_{SP} and scrambling codes C_{SC} that are available in the mobile radio system are stored in a code memory CDS. The code elements of these codes are referred to as chips. The codes are available not only for the calculation unit CU for calculation of the equalizer coefficients, but also for the RAKE finger section RF of the RAKE receiver.

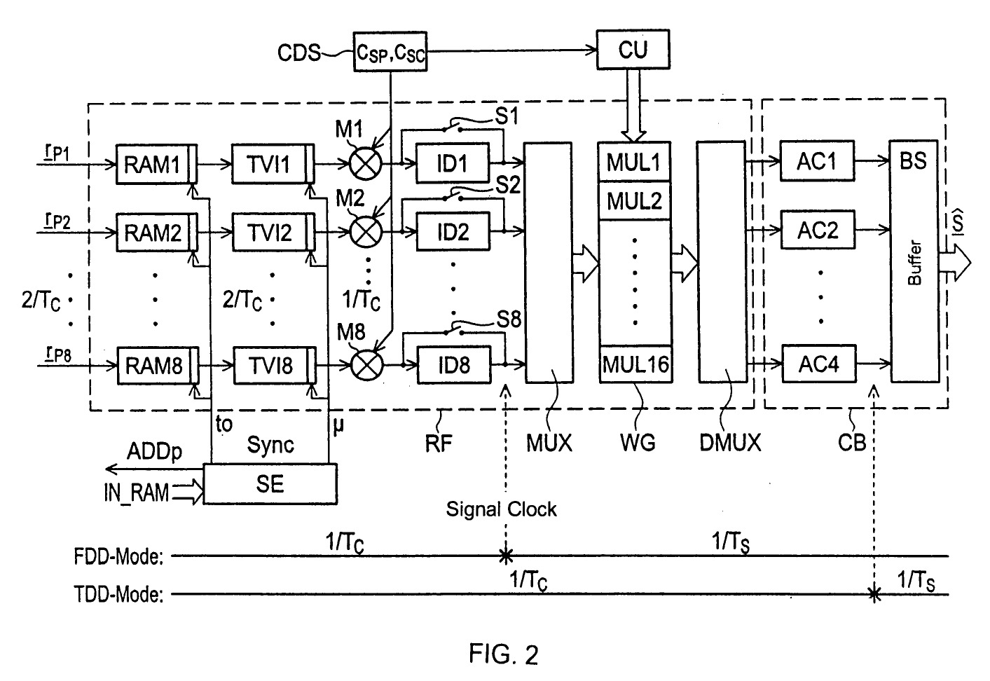

FIG. 2 shows the RAKE finger section RF, as illustrated in FIG. 1, and the combiner CB in greater detail.

As can be seen from FIG. 2, the RAKE finger section RF has, for example, eight (hardware) RAKE fingers. On the input side, each of the RAKE fingers has a random access memory RAM1-8, downstream of which there is a time-variant interpolator TVI1-8 and, as the signal path continues, a multiplier M1-8, an integrate and dump unit ID1-8 and the already mentioned weighting unit WG. The integrate and dump units ID1-8 may each be bridged via switches S1-8, respectively. As illustrated in FIG. 2 and as will be explained in more detail later, the weighting unit WG may optionally have a multiplexer MUX connected upstream of it, and a demultiplexer DMUX connected downstream of it.

The method of operation of the RAKE finger section RF is now described.

First, let us consider the reception of a signal, which has been transmitted from a single subscriber, in the FDD mode. The fundamental principle of RAKE receivers, which is known per se, contains each RAKE finger being associated with one, and only one, path (subchannel) through the air interface. Therefore, the received data items r_{P1}, r_{P2} and r_{P8} which are passed to the inputs of the individual RAKE fingers represent different versions of one and the same transmitted signal, which have reached the receiver via different propagation paths P1, P2, . . . , P8 through the air interface.

The subdivision of the sample values (data r into the individual path components r_{P1}, r_{P2}, . . . , r_{P8} is carried out under the control of the search and synchronization unit SE using the path information ADD_{P}. ADD_{P} indicates address areas in the input memory IN_RAM in which sample values relating to the same transmission path are stored, and therefore sample values are read on a path-related basis from the input memory IN_RAM, and the corresponding data items r_{P1}, r_{P2}, . . . , r_{P8} are passed to the individual RAKE fingers. The path information ADD_{P} is also passed to the channel estimator CE.

The synchronization information Sync that is emitted from the search and synchronization unit SE contains signals “to” and “μ” for each RAKE finger. The signals to represent individual time-controlled read instructions for the memory RAM1-8, and result in rough synchronization of the individual RAKE fingers to an accuracy of T_{c}.

The fine synchronization is carried out by the interpolators TVI1-8 by interpolation of the sample values in the respective RAKE fingers as a function of the individual interpolation signals μ. The interpolation signals μ are determined, for example by an early/late correlator, in the search and synchronization unit SE.

The interpolation of the sample values allows the sampling rate in each RAKE finger to be reduced to 1/T_{c}, that is to say each chip is represented by one signal value. The signals downstream of the interpolators TVI1-8 are synchronized with an accuracy of at least T_{c}/2.

In summary, the memory RAM1-8 and the interpolators TVI1-8 provide compensation for the different path delay times of a subscriber signal which is subject to multipath propagation.

By way of example, MF equalization is carried out in the FDD mode. For this purpose, the signals which are produced on the output side of the interpolators TVI1-8 are first despread by multipliers M1-8 (spreading code: Cₛₚ) and are descrambled (scrambling code: C_{SC}). This is done by direct, chip-by-chip multiplication of these two code sequences onto the signals (which are likewise at the chip clock rate).

The switches S1-S8 are open. The despread and descrambled data signals are accumulated over a symbol time period T_{S} by the integrate and dump units ID1, ID2, . . . ID8. The accumulation results in the signal rate in each RAKE finger being reduced to the value 1/T_{S}.

The symbol time period T_{S} is dependent on the spreading factor Q of the spreading code C_{SP} that is used. The spreading factor Q indicates the number of chips per data symbol, that is to say Q=T_{S}/T_{C}. In the FDD mode for UMTS, Q may assume values of between 2 and 512.

The path-related data symbols, which are now at the symbol clockrate, are multiplied by multipliers MUL1, MUL2, . . . , MUL16 in the weighting unit WG by the corresponding MF equalizer coefficients which are emitted at the symbol clock rate from the calculation unit CU. In the process, each data symbol is multiplied by one equalizer coefficient.

The number of multipliers MUL1-16 should be chosen such that sufficient multiplication capacity is available even for a low spreading factor Q. 16 multipliers MUL1-16 are used in the present example. Since the multiplexing of the RAKE fingers results in their effective number possibly being greater than the number of multipliers MUL1-16 (as will be explained in the following text), the signals from the individual RAKE fingers are distributed between the multipliers MUL1-16 via a multiplexer MUX as well as suitable buffer stores, which are not described here. The demultiplexer DMUX reverses the combining of the signals once again on the individual multipliers MUL1-16. Path-related signals are thus once again produced on the outputs of the demultiplexer DMUX.

The combiner CB has, for example, four accumulators AC1, AC2, AC3, AC4. Each individual accumulator AC1, AC2, AC3, AC4 operates as a maximum ratio combiner (MRC), that is to say it once again joins the path versions that are produced at the output of the RAKE finger section RF together to form a subscriber signal. If only a single subscriber signal is detected (that is to say in the FDD mode, where only signal versions relating to this subscriber signal are processed in the RAKE receiver), only one accumulator is required, for example, AC1. The signal that has been combined in this way is temporarily stored in a buffer store BS, and forms the reconstructed, transmitted subscriber signal ŝ.

The method of operation of the RAKE finger section RF for multiple subscriber equalization in the TDD mode differs from the method of operation as described above for the FDD mode by the sample values r being split between the individual RAKE fingers. In this case, the RAKE fingers are not associated with specific paths through the air interface and thus the RAKE fingers are not all synchronized on a path-specific basis either.

Instead of this, only a first RAKE finger is synchronized to one channel, and a fixed relative time offset of in each case one symbol time period, that is to say Q chips, is set between the remaining fingers. This is achieved, for example, by all the other RAKE fingers each accessing the data that is stored in the memories RAM1, RAM2, . . . , RAM8 with a time offset T_{c}·Q with respect to the previous finger. These data items are identical, which results in that the data stored in the memories RAM1, RAM2, . . . , RAM8 in each case contains the sample values r.

A further difference from the FDD mode is that, as already mentioned, JD equalization is carried out in the TDD mode. The major difference between the TDD mode and the FDD mode is that the weighting unit WG operates at the chip clock rate, that is to say the calculation unit CU calculates the equalizer coefficients chip-by-chip, and the weighting unit WG multiples these chip-by-chip onto the signals in the RAKE fingers. The despreading and descrambling of the received signals are carried out during the equalization process in the TDD mode.

As a consequence of this, no despreading/descrambling of the signals is carried out by the multipliers M1-8 in the TDD mode, and the integrate and dump units ID1-8 are bridged by closing the switches S1-8 in the TDD mode. This results in the output signals from the interpolators TVI1-8 still being at the chip clockrate 1/T_{c} at the input to the multiplexer MUX.

The components of the detected subscriber signals are joined together by accumulators AC1-4 in the signal path downstream of the weighting unit WG. In this case as well, each accumulator AC1-4 is associated with one subscriber signal or channel and carries out an MRC operation with respect to this—as in the FDD mode. However, in the TDD mode, each accumulator AC1-4 also operates as an integrate and dump unit, that is to say reduces the signal clock rate from the chip clock rate to the symbol clock rate.

In contrast to the possible signal rates (chip rate or symbol rate), the processing frequencies that are used in the respective units may each differ for both modes. This is done in particular by what hardware functional units in the RAKE receiver are multiplexed and are thus used “more than once”. This will be explained in the following text with reference to a configuration suitable for multimode operation of the RAKE structure illustrated in FIGS. 1 and 2.

This is based on the assumption of the baseband section of the RAKE receiver, as illustrated in FIG. 2, containing 8 hardware RAKE fingers, 16 hardware multipliers MUL1-16 and four hardware accumulators AC1-4. Another assumption is quadruple multiplexing (not illustrated) of each (hardware) RAKE finger, so that 32 RAKE fingers (8 actual fingers and 24 virtual fingers) are effectively available. Furthermore, each RAKE finger is formed on a two-channel basis (in a manner which is likewise not illustrated) since, as already explained, I and Q components of the data items r_{P1}, r_{P2}, . . . , r_{P8} must in each case be processed. If it is also remembered that a complex multiplication operation contains four real multiplication operations, the number of multiplication operations to be carried out in the two modes by the multipliers MUL1-16 in the weighting unit WG is now described.

FDD mode: 256 real multiplication operations (4 real multiplication operations×2 components×32 fingers) must be carried out per symbol time period T_{S}=Q·T_{c}; since a maximum signal rate of 1/T_{S}=1/(2·T_{c})=2.048 MHz results for Q=2, a total of 256 real multiplication operations must be carried out within T_{S}=488 ns in the worst case (Q=2). If there are 16 multipliers MUL1-16, a multiplication must then be completed at the latest after 30.51 ns. This condition is satisfied for a processing frequency of 32 MHz.

TDD mode: 64 complex multiplication operations, that is to say 256 real multiplication operations, must be carried out per chip time period T_{c}; 256 multiplication operations must therefore be carried out in 244 ns with a chip rate of 1/T_{c}=4.096 MHz. Since, in consequence, a multiplication operation must be completed at the latest after 15.25 ns when there are 16 multipliers, the multiplication field MUL1-16 must be clocked at a processing frequency of 64 MHz.

Therefore, the processing frequency required for the weighting unit WG in the FDD mode is dependent on the spreading factor Q and is 32 MHz/Q. Subject to the stated preconditions, it is always 64 MHz in the TDD mode, irrespective of the spreading factor Q.

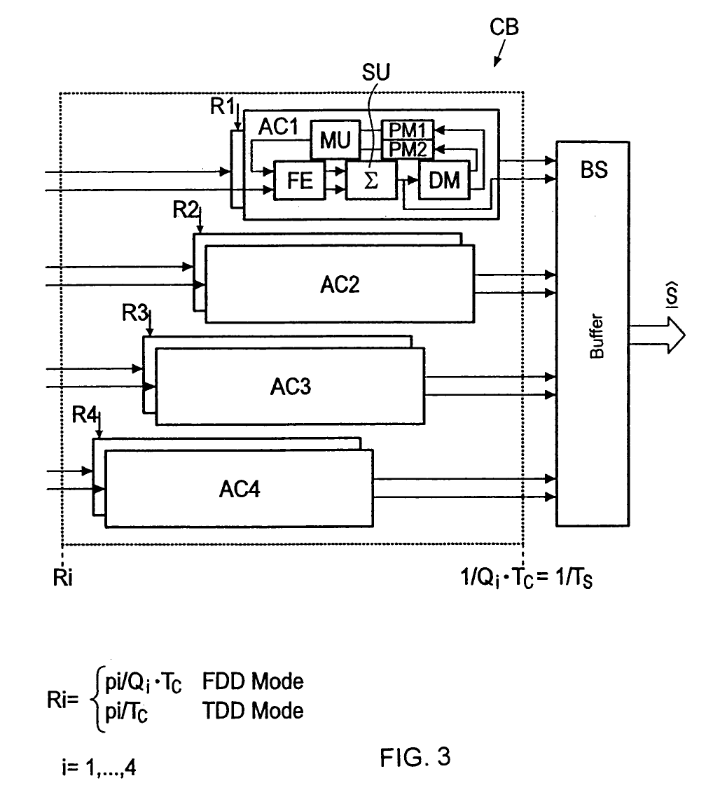

FIG. 3 shows the combiner CB in greater detail. As can be seen from FIG. 3, each complex accumulator AC1-4 is configured to accumulate the I and Q signal components for two channels. As already mentioned, each complex accumulator AC1-4 is associated with one, and only one, physical channel, for example the DPCH (Dedicated Physical Control Channel). Each accumulator AC1-4 contains an enable unit FE, an adder SU, a demultiplexer DM, two buffer stores PM1, PM2 and a multiplexer MU, whose output is passed to the enable unit FE.

pᵢ denotes the total number of available (actual and multiplexed) RAKE fingers which are associated with an i-th physical channel. The number pi corresponds to the number of detected paths for the channel. The spreading factor that is used in this channel is denoted Qᵢ (the spreading factors that are used in the channels may differ).

At the input of the accumulator ACi, i=1, . . . , 4, which is associated with the i-th physical channel, a data rate Rᵢ=pᵢ/(Qᵢ·T_{c}) which is related to this channel occurs in the FDD mode, that is to say pᵢ times the symbol rate (since pᵢ equalized data symbols must be combined per symbol time period). In the TDD mode, the channel-related data rate Rᵢ at the input of an accumulator is always pᵢ/T_{c} (pᵢ equalized chips must be combined per chip time period).

In the FDD mode, the channel-related data rate at the output of the accumulator is ACi 1/(Qᵢ·T_{c})=1/Tₛ, since pᵢ incoming data symbols are combined to form one data symbol. The combined data symbols are emitted unchanged at the symbol clock rate.

In the TDD mode, the signal clock rate is converted to the symbol clock rate by accumulation of the individual chips over one symbol time period. The accumulators AC1-4 are thus used not only for a combination of the signals from different RAKE fingers but, furthermore, also act as an integrate and dump unit in the TDD mode. In the TDD mode, the channel-related data rate at the output of the accumulator is also 1/(Qᵢ·T_{c})=1/Tₛ.

The use of a RAKE receiver structure for carrying out JD equalization is based on the fact that the system matrix of a JD transmission system can be mapped onto the system matrix of a RAKE receiver which is oversampled Q times. This will now be explained in detail.

A transmission channel from the k-th subscriber is described by a matrix A_{G}^{(k)} of dimension Wₛ·QX(Lₛ+Wₛ−1) in the chip clock channel model, represented in the matrix vector form, and this describes both the transmitter-end signal processing by multiplication of spreading codes and scrambling codes onto the data symbols s to be transmitted, and the signal distortion which is suffered during transmission via the air interface. Lₛ denotes the channel length in symbols, that is to say the number of symbols taken into account for the channel memory, and Wₛ denotes the (selectable) number of symbols taken into account for the equalization process. In a corresponding manner, L denotes the channel length in chips on the basis of the chip clock channel model, and W denotes the number of chips taken into account for the equalization process (length of the equalizer in chips). Thus, Lₛ=ceil{L/Q} and Wₛ=ceil{W/Q}, where ceil {·} is rounded to the next higher integer number. A superscript T denotes the transposed vector or the transposed matrix, and underscores indicate that a variable is a complex value.

A sequence containing Lₛ+Wₛ−1 data symbols {s^{k}_{n-L}_{ₛ}⁺¹, . . . ,sₙ^{k}, . . . ,s^{k}_{n+W}_{ₛ}⁻¹} to be transmitted for the k-th subscribed is described in the vector matrix form by the (column) vector s^{(k)}ₙ=(s^{k}_{n-L}_{ₛ}⁺¹. . .s^{k}_{n+W}_{ₛ}⁻¹)^{T} of dimension (Lₛ+Wₛ−1)×1 relating to the n-th time step.

With regard to all K subscribers, the so-called “combined” vector of all the transmitted data symbols, relating to the n-th time step, is formed using

sₙ=(sₙ^{(1)T} . . .sₙ^{(k)T} . . .sₙ^{(K)T})^{T} (1)

The “combined” vector has the dimension K·(Lₛ+Wₛ−1)×1.

The transmitted data symbols are spread-coded, are each transmitted via two or more paths to the receiver, and are equalized there by joint detection (JD).

The equation for the reconstruction ŝₙ^{k} of the data symbol that is transmitted by the k-th subscriber with respect to the time step n is, in the receiver, as follows:

ŝ^{k}ₙ=m^{(k)}rₙ

where rₙ=A_{G}sₙ (2)

In this case, the entire multiple subscriber system containing K subscribers (including spread coding and signal distortion which occurs during signal transmission) is described by the so-called multiple subscriber system matrix A_{G} of dimension Wₛ·Q×K(Lₛ+Wₛ−1).

The vector rₙ represents the received data at the chip clock rate. The receiver-end JD equalization of the received data from the k-th subscriber is in this model provided by an equalizer vector m^{(k)} of dimension 1×Wₛ·Q, which is calculated on the basis of the estimated channel coefficients by the calculation unit CU. The Wₛ·Q elements of the equalizer vector m^{(k)} are the equalizer coefficients for the k-th subscriber. The calculation rule for the equalizer vector m^{(k)} is dependent on the chosen equalizer algorithm. This will be described later for the case of ZF equalization.

The multiple subscriber system matrix A_{G} is obtained in the following manner from system matrices A_{G}^{(k)} of dimension Wₛ·Q×(Lₛ+Wₛ−1) for the individual subscribers:

A_{G}=└A_{G}⁽¹⁾ A_{G}⁽²⁾ . . . A_{G}^{(K)}┘ (3)

The subscriber system matrices A_{G}^{(k)} are defined by:

$${\underline{A}}_{G}^{( k )} = [ \begin{matrix}[ {\underline{A}}^{′ ( k )} ] 0 … 0 \\ 0 [ {\underline{A}}^{′ ( k )} ] 0 … 0 \\ 00 [ {\underline{A}}^{′ ( k )} ] 0 … 0 \\ 0 … 0 [ {\underline{A}}^{′ ( k )} ]\end{matrix} ] \qquad ( 4 )$$

where A′^{(k)} in the general case is a matrix of dimension Q×Lₛ which is quoted here, in order to improve the representation, for the special case of Lₛ=2 (that is to say the dimension Q×2).

$${\underline{A}}^{′ ( k )} = [ \begin{matrix}{\underline{a}}_{Q + 1}^{( k )} & {\underline{a}}_{1}^{( k )} \\ {\underline{a}}_{Q + 2}^{( k )} & {\underline{a}}_{2}^{( k )} \\ ⋮ & ⋮ \\ {\underline{a}}_{Q + L - 1}^{( k )} & {\underline{a}}_{L - 1}^{( k )} \\ 0 & {\underline{a}}_{L}^{( k )} \\ ⋮ & ⋮ \\ 0 & {\underline{a}}_{Q}^{( k )}\end{matrix} ] \qquad ( 5 )$$

The elements in the matrix A′^{(k)} are obtained from the respectively used spreading codes and channel characteristics:

a^{(k)}=C′^{(k)} h^{(k)T} (6)

In this case, a^{(k)}=(a₁^{(k)} . . . a_{Q+L-1}^{(k)})^{T} is a vector of dimension (Q+L−1)×1 and C′^{(k)} is a matrix which is produced by the spreading code Cₛₚ for the k-th subscriber under consideration, in this case denoted c^{(k)}=(c₁^{k} . . . c_{Q}^{k})

$${C}^{′ ( k )} = [ \begin{matrix}{\underline{c}}_{1}^{k} & 0 & ⋯ & 0 \\ {\underline{c}}_{2}^{k} & {\underline{c}}_{1}^{k} & & ⋮ \\ ⋮ & {\underline{c}}_{2}^{k} & & \\ {\underline{c}}_{Q}^{k} & & & ⋮ \\ 0 & {\underline{c}}_{Q}^{k} & & 0 \\ ⋮ & \cdot & & {\underline{c}}_{1}^{k} \\ & & \cdot & {\underline{c}}_{2}^{k} \\ ⋮ & & & ⋮ \\ 0 & ⋯ & 0 & {\underline{c}}_{Q}^{k}\end{matrix} ] \qquad ( 7 )$$

of dimension (Q+L−1)×L.

h^{(k)}=(h₁^{k} . . . h_{L}^{k})^{T} is the (column) vector which is formed from the channel impulse response h₁^{k}, h₂^{k}. . . , h_{L}^{k} of length L for the k-th subscriber (as already mentioned, L denotes the channel length (channel memory) in chips).

To simplify the representation, it is assumed that no scrambling code is used.

An analogous description of a transmission system (but relating to block-by-block data transmission) is known from the prior art and is described in detail on pages 188-215 of the book titled “Analyse und Entwurf digitaler Mobilfunksysteme” [Analysis and Design of Digital Mobile Radio Systems] by P. Jung, B. G. Teubner Verlag Stuttgart, 1997. This literature reference is incorporated by reference into the subject matter of the present document.

As is obvious, the “equalizer” m^{(k)} which is required to calculate a transmitted data symbol from the k-th subscriber contains Q “sub-equalizers” of length Wₛ. Therefore, a RAKE receiver operated with Q-times oversampling is required for JD equalization. It is also obvious from the above analysis that the despreading is an integral component of the equalization process.

In the case of ZF equalization, the equalizer coefficients (that is to say the elements of the equalizer vector m^{(k)}) are calculated by solving the equation system:

m^{(k)}A_{G}=ζⱼ (8)

In this case, ζⱼ is a 1×K·(Lₛ+Wₛ−1) (row) vector, which predetermines the ZF condition for a specific (k-th) subscriber. The ZF vector ζⱼ can be represented as follows:

ζⱼ=(0 . . . 010 . . . 0) (9)

with the 1 in the j-th position representing

j=(k−1) (Lₛ+Wₛ−1)+1 . . . , k(Lₛ+Wₛ−1).

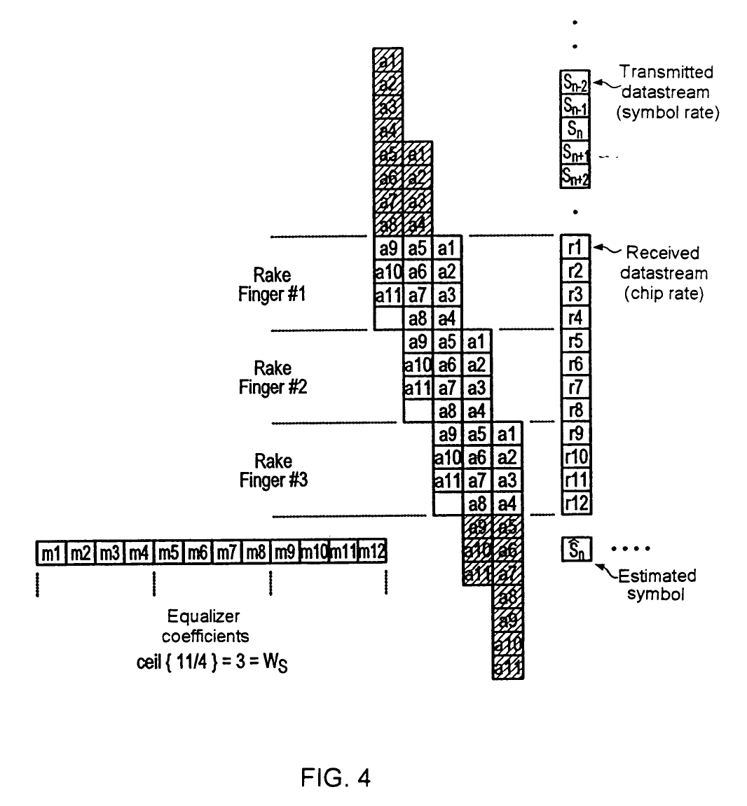

FIG. 4 shows the calculation of ŝₙ^{k} for Q =4, Wₛ=3, Lₛ=3 (L and W are 11 in this case) and K=1 by the RAKE receiver on the basis of a representation of a detail of the system matrix A_{G}, the equalizer coefficients m1 to m12, the data items sₙ₋₂ to sₙ₊2 transmitted (by the one subscriber) (at the symbol rate), the received data items r1 to r12 (at the chiprate) and the data symbol ŝₙ estimated for the n-th time step (underscores are ignored). One and only one finger, which is oversampled Q times, of the RAKE receiver is used for every Q chips. The RAKE finger #1 processes the first received Q chips, the RAKE finger #2 processes the second Q chips delayed by Q chips, etc. Therefore, the input signal to each RAKE finger is a signal that has been oversampled Q times. Each sample value contains the same information with regard to the transmitted data symbol, but different information with regard to the spreading code used (and the scrambling code if appropriate) and the transmission channel.

ZF equalization and a possible method for solving the equation 8 are described in detail in Published, Non-Prosecuted German Patent Application DE 101 06 391 A1, which is hereby incorporated by reference herein.

We claim:

1. A RAKE receiver for receiving signals transmitted by different propagation paths of a transmission channel and spread-coded with chip sequences in frequency division duplex (FDD) and time division duplex (TDD) modes, the rake receiver comprising:
at least two RAKE fingers;
an equalizer connected to said RAKE fingers for equalization of the signals processed in individual ones of said RAKE fingers, using equalizer coefficients; and
means for calculating the equalizer coefficients for the FDD and TDD modes selectively, the equalizer coefficients for the TDD mode being calculated using a multiple subscriber method on a propagation path non-specific basis for each chip of the signals to be equalized, and being applied to the signals, said means for calculating being connected to said equalizer.

2. The RAKE receiver according to claim 1, wherein:
said rake fingers each have a unit for signal rate reduction disposed in a signal path upstream of said equalizer; and
said rake fingers each have a means for bridging said unit for signal rate reduction.

3. The RAKE receiver according to claim 2, wherein each of said rake fingers has despreading means for despreading the signals being processed in said RAKE fingers, said despreading means disposed in the signal path upstream of said unit for signal rate reduction in each of said RAKE fingers, said despreading means being deactivated in the TDD mode.

4. The RAKE receiver according to claim 3, wherein said despreading means is a multiplier.

5. The RAKE receiver according to claim 2, wherein said unit for signal rate reduction is an accumulator.

6. A RAKE receiver for receiving signals transmitted by different propagation paths of a transmission channel and spread-coded with chip sequences in frequency division duplex and time division duplex modes, the rake receiver comprising:
at least two RAKE fingers;
an equalizer connected to said RAKE fingers for equalization of the signals processed in individual ones of said RAKE fingers, using equalizer coefficients; and
a calculation unit for generating the equalizer coefficients for the FDD and TDD modes selectively, the equalizer coefficients for the TDD mode being calculated using a multiple subscriber method on a propagation path non-specific basis for each chip of the signals to be equalized, and being applied to the signals, said calculation unit connected to said equalizer.
